(19) United States
(12) Patent Application Publication
(10) Pub. No.: US 2011/0075732 A1
(43) Pub. Date: Mar. 31, 2011

(54) APPARATUS AND METHOD FOR ENCODING AND DECODING MOVING IMAGES

(76) Inventors: Naofumi WADA, Yokohama-shi (JP); Takeshi Chujoh, Kawasaki-shi (JP); Akiyuki Tanizawa, Kawasaki-shi (JP); Goki Yasuda, Kawasaki-shi (JP); Takashi Watanabe, Fuchu-shi (JP)

(21) Appl. No.: 12/889,459

(22) Filed: Sep. 24, 2010

Related U.S. Application Data
(63) Continuation of application No. PCT/JP2009/058266, filed on Apr. 27, 2009.

(30) Foreign Application Priority Data
Apr. 30, 2008 (JP) 2008-118885

(51) Int. Cl. H04N 7/50

(52) U.S. Cl. 375/240.12; 375/E07.211

(57) ABSTRACT

According to an embodiment, a moving image encoding method includes generating a predicted image of an original image based on a reference image, performing transform and quantization on a prediction error between the original image and the predicted image to obtain a quantized transform coefficient, performing inverse quantization and inverse transform on the quantized transform coefficient to obtain a decoded prediction error, adding the predicted image and the decoded prediction error to generate a local decoded image, setting filter data containing time-space filter coefficients for reconstructing the original image based on the local decoded image and the reference image, performing a time-space filtering process on the local decoded image in accordance with the filter data to generate a reconstructed image, storing the reconstructed image as the reference image, and encoding the filter data and the quantized transform coefficient.

### CROSS-REFERENCE TO RELATED APPLICATIONS

This is a Continuation Application of PCT application No. PCT/JP2009/058266, filed Apr. 27, 2009, which was published under PCT Article 21 (2) in Japan.

This application is based upon and claims the benefit of priority from prior Japanese Patent Application No. 2008-118885, filed Apr. 30, 2008, the entire contents of which are incorporated herein by reference.

### FIELD

Embodiments described herein relate generally to an apparatus and method for encoding moving images and also to an apparatus and method for decoding encoded moving images.

### BACKGROUND

Hitherto, in moving-picture encoding systems such as H.264/AVC, the prediction error between an original image and a predicted image for one block is subjected to orthogonal transform and quantization, thereby generating coefficients, and the coefficients thus generated are encoded. If an image thus encoded is decoded, the decoded image has block-shaped encoding distortion called “block distortion.” The block distortion impairs the subjective image quality. In order to reduce the block distortion, a de-blocking filtering process is generally performed, in which a low-pass filter is used for processing the boundaries between the blocks in a local decoded image. The local decoded image having the block distortion reduced is stored, as reference image, in a reference image buffer. Thus, if the de-blocking filtering process is utilized, motion-compensated prediction is accomplished on the basis of the reference image with the reduced block distortion. The de-blocking filtering process prevents the block distortion from propagating in time direction. Note that the de-blocking filter is also known as a “loop filter,” because it is used in the loops of the encoding apparatus and decoding apparatus.

The motion-compensated, interframe encoding/decoding apparatus described in Japanese Patent No. 3266416 performs a filtering process in time direction before a local decoded image is stored, as reference image, in a reference image buffer. That is, the reference image used to generate a predicted image corresponding to the local decoded image is utilized, performing a filtering process in time direction, thereby obtaining a reconstructed image. This reconstructed image is saved in the reference image buffer as the reference image that corresponds to the local decoded image. In the motion-compensated, interframe encoding/decoding apparatus described in Patent Publication No. 3266416, the encoding distortion of the reference image can be suppressed.

JP-A 2007-274479 (KOKAI) describes an image encoding apparatus and an image decoding apparatus, in which a filtering process is performed in time direction on the reference image used to generate a predicted image, by using a local decoded image corresponding to the predicted image. That is, the image encoding apparatus and image decoding apparatus, both described in JP-A 2007-274479 (KOKAI), use the local decoded image, performing the temporal filtering process in the reverse direction, thereby generating a reconstructed image, and use this reconstructed image, updating the reference image. Hence, the image encoding apparatus and image decoding apparatus, described in JP-A 2007-274479 (KOKAI), can update the reference image every time it used to generate a predicted image, whereby the encoding distortion is suppressed.

The de-blocking filtering process is performed, not for the purpose of rendering the local decoded image or the decoded image similar to the original image. The filtering process may blur the block boundaries too much, possibly degrading the subjective image quality. Further, the motion-compensated, interframe encoding/decoding apparatus described in Patent Publication No. 3266416, and the image encoding apparatus and image decoding apparatus described in JP-A 2007-274479 (KOKAI) are similar to the de-blocking filtering process in that they do not aim to render the local decoded image or the decoded image similar to the original image.

S. Wittmann and T. Wedi, “Post-filter SEI message for 4:4:4 coding”, JVT of ISO/IEC MPEG & ITU-T VCEG, JVT-S030, April 2006 (hereinafter referred to as the “reference document”) describes a post filtering process. The post filtering process is performed in the decoding side, for the purpose of enhancing the quality of a decoded image. More specifically, the filter data necessary to the post filtering process, such as filter coefficient and filter size, is set in the encoding side. The filter data is output, multiplexed with an encoded bitstream. In the decoding side, the post filtering process is performed on the decoded image, on the basis of the filter data. Therefore, the post filtering process can improve the decoded image in quality, if such filter data as would reduce the error between the original image and the decoded image.

In the post filtering process described in the reference document is performed on the decoded image, in the decoding side only. That is, the post filtering process is not performed on the reference image that is used to generate a predicted image. Therefore, the post filtering process does not serve to increase the encoding efficiency. Moreover, the post filtering process is a filtering process performed in spatial direction, not including a temporal filtering process.

### BRIEF DESCRIPTION OF THE DRAWINGS

FIG. 1 is a block diagram of a moving image encoding apparatus according to a first embodiment;

FIG. 2 is a block diagram of a moving image decoding apparatus according to the first embodiment;

FIG. 3 is a flowchart showing a part of the operation the moving image encoding apparatus of FIG. 1 performs;

FIG. 4 is a flowchart showing a part of the operation the moving image decoding apparatus of FIG. 2 performs;

FIG. 5 is a block diagram of a moving image encoding apparatus according to a second embodiment;

FIG. 6 is a block diagram of a moving image decoding apparatus according to the second embodiment;

FIG. 7 is a block diagram of a moving image encoding apparatus according to a third embodiment;

FIG. 8 is a block diagram of a moving image decoding apparatus according to the third embodiment;

FIG. 9 is a diagram explaining the processes a filter data setting unit 108 and a filtering process unit 109 perform;

FIG. 10 is a diagram showing the syntax structure of an encoded bitstream; and

FIG. 11 is a diagram showing an exemplary description of filter data.

### DETAILED DESCRIPTION

In general, according to one embodiment, a moving image encoding method includes generating a predicted image of an original image based on a reference image; performing transform and quantization on a prediction error between the original image and the predicted image to obtain a quantized transform coefficient; performing inverse quantization and inverse transform on the quantized transform coefficient to obtain a decoded prediction error; adding the predicted image and the decoded prediction error to generate a local decoded image; setting filter data containing time-space filter coefficients for reconstructing the original image based on the local decoded image and the reference image; performing a time-space filtering process on the local decoded image in accordance with the filter data to generate a reconstructed image; storing the reconstructed image as the reference image; and encoding the filter data and the quantized transform coefficient.

According to another embodiment, a moving image decoding method includes decoding an encoded bitstream in which filter data and a quantized transform coefficient are encoded, the filter data containing time-spatial filter coefficients for reconstructing an original image based on a decoded image and a reference image, and the quantized transform coefficient having been obtained by performing predetermined transform/quantization on a prediction error; performing inverse quantization/inverse transform on the quantized transform coefficient to obtain a decoded prediction error; generating a predicted image of the original image based on the reference image; adding the predicted image and the decoded prediction error to generate the decoded image; performing time-space filtering process on the decoded image in accordance with the filter data to generate a reconstructed image; and storing the reconstructed image as the reference image.

Embodiments will be described with reference to the accompanying drawings.

### First Embodiment

### Moving Image Encoding Apparatus

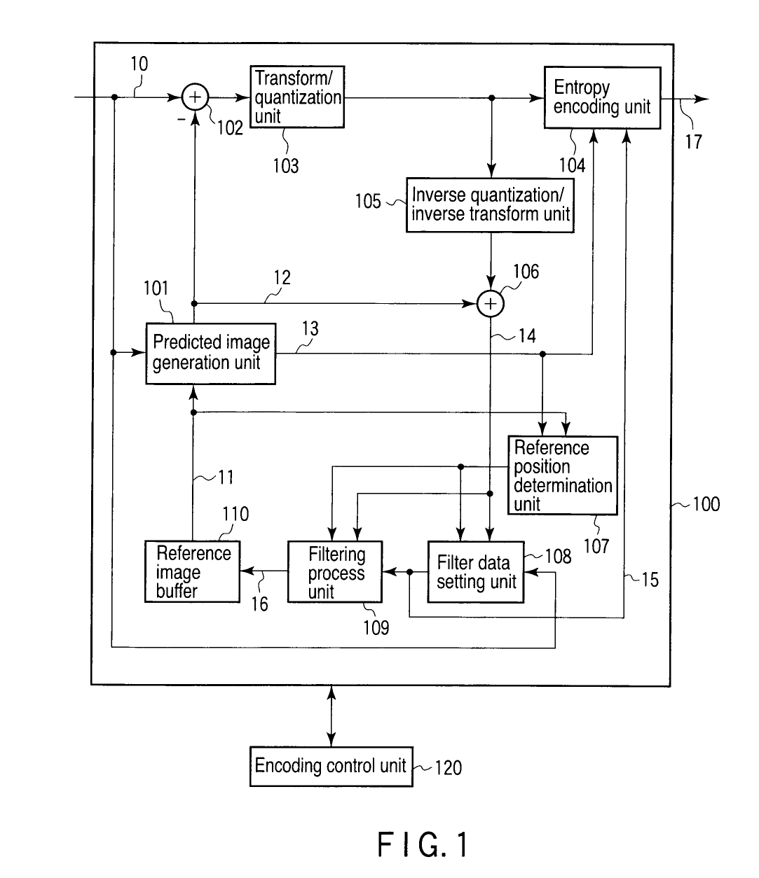

As FIG. 1 shows, a moving image encoding apparatus according to a first embodiment has an encoding unit 100 and an encoding control unit 120. The encoding unit 100 includes a predicted image generation unit 101, a subtraction unit 102, a transform/quantization unit 103, an entropy encoding unit 104, an inverse quantization/inverse transform unit 105, an addition unit 106, a reference position determination unit 107, a filter data setting unit 108, a filtering process unit 109 and a reference image buffer 110. The encoding control unit 120 controls the encoding unit 100. The encoding control unit 120 performs various controls such as feedback control of code rate, quantization control, prediction mode control and motion prediction accuracy control.

The predicted image generation unit 101 predicts an original image for one block and generates a predicted image 12. The predicted image generation unit 101 reads an already encoded reference image 11 from a reference image buffer 110, which will be described later, and then performs motion prediction by using, for example, block matching, thereby detecting a motion vector that indicates the motion of the original image 10 based on the reference image 11. Next, the predicted image generation unit 101 generates predicted image 12 by motion-compensating the reference image 11 in accordance with the motion vector. The predicted image generation unit 101 inputs the predicted image 12 to the subtraction unit 102 and addition unit 106. The predicted image generation unit 101 inputs motion information 13 to the entropy encoding unit 104 and reference position determination unit 107. The motion information 13 is, for example, the aforementioned motion vector, but not limited to it. Rather, it may be data necessary to the motion-compensated prediction. Note that the predicted image generation unit 101 may perform intra prediction instead of the motion-compensated prediction in order to generate a predicted image 12.

The subtraction unit 102 receives the predicted image 12 from the predicted image generation unit 101, and subtracts the predicted image 12 from the original image 10, thereby obtaining a prediction error. The subtraction unit 102 then inputs the prediction error to the transform/quantization unit 103. The transform/quantization unit 103 performs orthogonal transform such as discrete cosine transform (DCT) on the prediction error output from the subtraction unit 102, thus obtaining a transform coefficient. The transform/quantization unit 103 may perform any other transform, such as wavelet transform, independent component analysis or Hadamard transform. The transform/quantization unit 103 quantizes the transform coefficient in accordance with the quantization parameter set by the encoding control unit 120 and generates a quantized transform coefficient. The quantized transform coefficient is input to the entropy encoding unit 104 and inverse quantization/inverse transform unit 105.

The entropy encoding unit 104 performs entropy encoding, such as Huffman coding or arithmetic coding, on the quantized transform coefficient supplied from the transform/quantization unit 103, the motion information 13 supplied from the predicted image generation unit 101 and the filter data 15 supplied from the filter data setting unit 108. The filter data setting unit 108 will be described later. The entropy encoding unit 104 performs a similar encoding on the prediction mode information representing the prediction mode of the predicted image 12, on block-size switching information and on the quantization parameter. The entropy encoding unit 104 outputs an encoded bitstream 17 generated by multiplexing encoded data.

The inverse quantization/inverse transform unit 105 performs inverse quantization on the quantized transform coefficient to obtain the transform coefficient. The quantized transform coefficient is supplied from the transform/quantization unit 103. The inverse quantization is performed in accordance with the quantization parameter. The inverse quantization/inverse transform unit 105 then performs an inverse transform on the transform coefficient to obtain a decoded prediction error. The inverse transform corresponds to the transform that the transform/quantization unit 103 has performed. The inverse quantization/inverse transform unit 105 performs, for example, inverse discrete transform (IDCT) or inverse wavelet transform. The decoded prediction error has been subjected to the aforementioned quantization/inverse quantization. Therefore, the decoded prediction error contains encoding distortion resulting from the quantization. The inverse quantization/inverse transform unit 105 inputs the decoded prediction error to the addition unit 106.

The addition unit 106 adds the decoded prediction error input from the inverse quantization/inverse transform unit 105, to the predicted image 12 input from the predicted image generation unit 101, thereby generating a local decoded image 14. The addition unit 106 outputs the local decoded image 14 to the filter data setting unit 108 and filtering process unit 109.

The reference position determination unit 107 reads the reference image 11 from the reference image buffer 110, and uses the motion information 13 supplied from the predicted image generation unit 101. The reference position determination unit 107 thereby determines a reference position, which will be described later. If the motion information 13 is a motion vector, the reference position determination unit 107 designates reference position on the reference image 11 indicated by the motion vector. The reference position determination unit 107 notifies the reference position to the filter data setting unit 108 and filtering process unit 109.

The filter data setting unit 108 uses the local decoded image 14 and the reference image 11 shifted in position with respect to the reference position determined by the reference position determination unit 107, thereby setting filter data 15 containing a time-space filter coefficient, which will be used to reconstruct the original image. The filter data setting unit 108 inputs the filter data 15 to the entropy encoding unit 104 and filtering process unit 109. The technique of setting the filter data 15 will be explained later in detail.

In accordance with the filter data 15 output from the filter data setting unit 108, the filtering process unit 109 uses the reference image 11 shifted in position with respect to the reference position determined by the reference position determination unit 107, performing a time-space filtering process and generating a reconstructed image 16. The filtering process unit 109 causes the reference image buffer 110 to store the reconstructed image 16 as reference image 11 associated with the local decoded image 14. The method of generating the reconstructed image 16 will be described later. The reference image buffer 110 temporarily stores, as reference image 11, the reconstructed image 16 output from the filtering process unit 109. The reference image 11 will be read from the reference image buffer 110, as is needed.

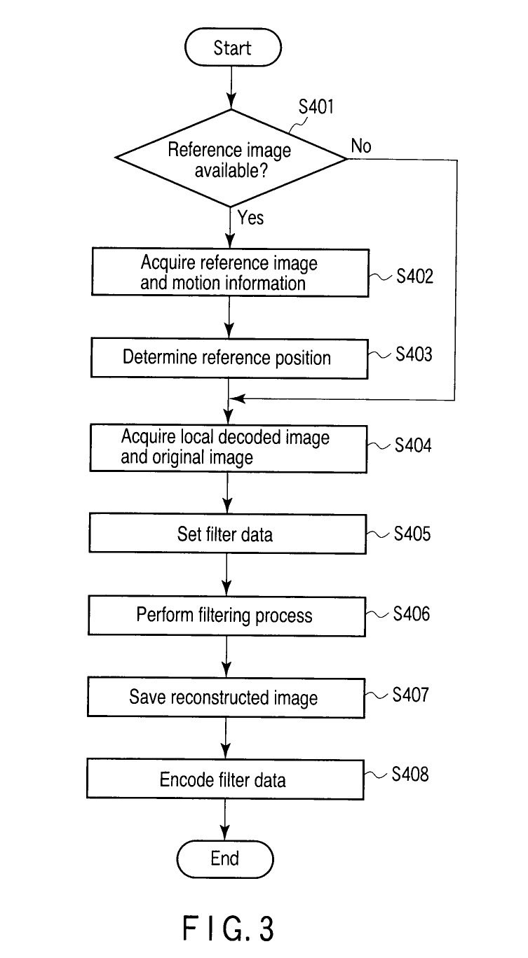

Setting process of the filter data 15 in this embodiment and generating process of the reconstructed image 16 in this embodiment will be explained with reference to the flowchart of FIG. 3.

First, it is determined whether the local decoded image 14 has been generated from the predicted image 12 that is based on the reference image 11 (Step S401). If the local decoded image 14 has been generated from the predicted image 12 that is based on the reference image 11, the reference position determination unit 107 obtains both the reference image 11 and the motion information 13 (Step S402). The reference position determination unit 107 then determines the reference position (Step S403). The process goes to Step S404. On the other hand, if the local decoded image 14 has been generated from the predicted image 12 that is not based on the reference image 11, Steps S401 to S403 are skipped, and the process goes to Step S404.

Examples of prediction based on the reference image 11 include the temporal prediction utilizing motion compensation and motion estimation based on block matching, such as the inter prediction in the H.264/AVC system. Examples of prediction not based on the reference image 11 include the spatial prediction based on the already encoded adjacent pixel blocks in the same frame, such as intra prediction in the H.264/AVC system.

In Step S404, the filter data setting unit 108 acquires the local decoded image 14 and the original image 10. If the reference position has been determined in Step S403, the filter data setting unit 108 will acquire the reference position of each reference image 11, too.

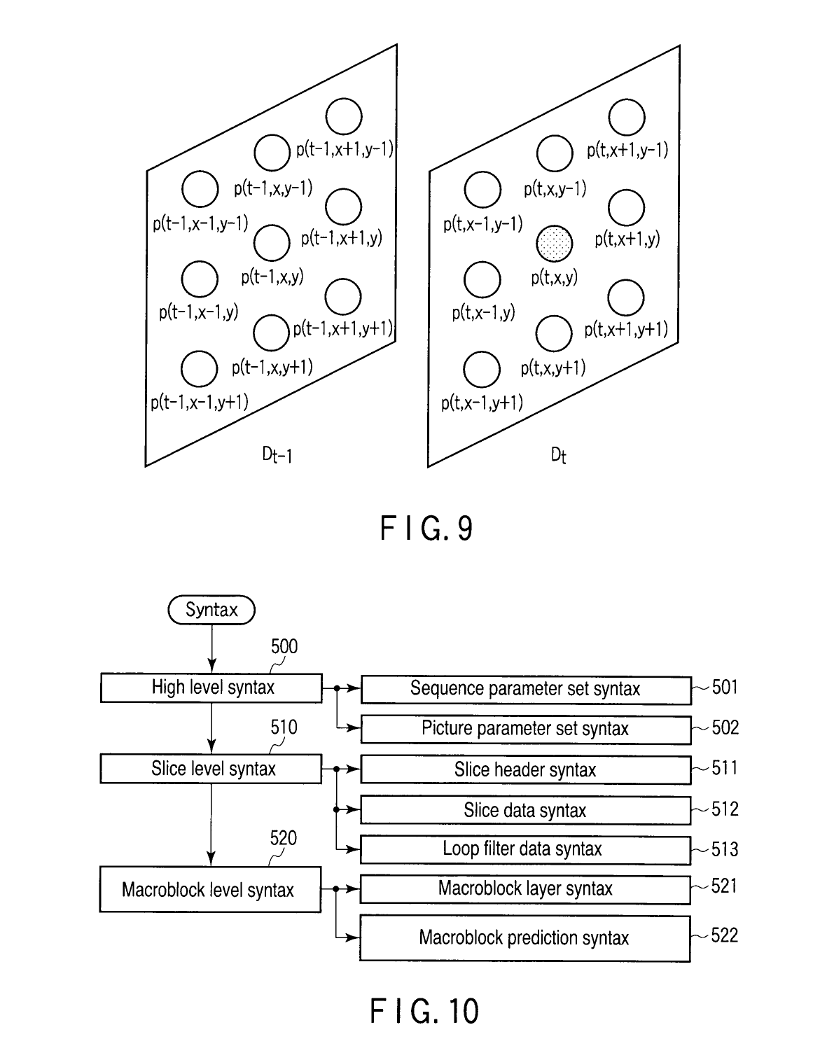

Next, the filter data setting unit 108 sets the filter data 15 (Step S405). The filter data setting unit 108 sets, for example, such a filter coefficient as will cause the filtering process unit 109 to function as a Weiner filter generally used as an image reconstructing filter and to minimize the mean square error between the reconstructed image 16 and the original image 10. How the filter coefficient is set and how the time-space filtering process is performed with a filter size of 2×3×3 (time direction×horizontal direction×vertical direction) pixels will be explained with reference to FIG. 9.

In FIG. 9, Dt is a local decoded image, and Dt-1 is a reference image, which has been used to generate a predicted image 12 associated with the local decoded image Dt. Assume that the reference image Dt-1 has been shifted in position with respect to the reference position determined by the reference position determination unit 107. Any pixel at coordinate (x,y) in the local decoded image Dt has pixel value p(t,x,y), and any pixel at coordinate (x,y) in the reference image Dt-1 has pixel value p(t−1,x,y). Therefore, the pixel value Rt(x,y) of a pixel at coordinate (x,y) in the reconstructed image 16 obtained as the filtering process unit 109 performs the time-space filtering process on a pixel at coordinate (x,y) in the local decoded image Dt is expressed by the following expression:

Rₜ(x,y)=Σₖ₌₋₁⁰Σⱼ₌₋₁¹Σᵢ₌₋₁¹h_{k,i,j}·p(t+k,x+i,y+j) (1)

In Expression (1), h_{k,i,j} is a filter coefficient set for pixel p(k,i,j) shown in FIG. 9. The filter coefficient h_{k,i,j} is set so that the mean square error between an original image Ot and a reconstructed image Rt may be minimized in the following expression:

$$E = {\sum }_{y} {\sum }_{x} {\{ {O}_{t} ( x , y ) - {R}_{t} ( x , y ) \}}^{2} \qquad ( 2 )$$

The filter coefficient h_{k,i,j} is obtained by solving the following simultaneous equation:

$$\frac{\partial E}{\partial h} = 0 \qquad ( 3 )$$

The filter coefficient h_{k,i,j}, thus obtained, and the filter size 2×3×3 are input, as filter data 15, not only to the filtering process unit 109, but also to the entropy encoding unit 104.

Next, the filtering process unit 109 performs a time-space filtering process in accordance with the filter data 15 set in Step S405 (Step S406). More specifically, the filtering process unit 109 applies the filter coefficient contained in the filter data 15 to a pixel of the local decoded image 14 and to a pixel of the reference image 11 shifted in position with respect to the reference position determined in Step S403, which takes the same position as the pixel of the local decoded image 14. The filtering process unit 109 thereby generates the pixels of a reconstructed image 16, one after another. The reconstructed image 16, thus generated, is saved in the reference image buffer 109 (Step S407).

The local decoded image 14 may be generated from a predicted image 12 not based on the reference image 11. In this case, p(t,x,y) and h_{k,i,j} are replaced by p(x,y) and h_{i,j}, respectively, in the expressions (1) to (3), and the filtering process unit 109 sets the spatial filter coefficient h_{i,j} (Step S405). The filtering process unit 109 performs a spatial filtering process in accordance with the spatial filter coefficient h_{i,j} to generate a reconstructed image 16 (Step S406).

The filter data 15 is encoded by the entropy encoding unit 104, multiplexed with the encoded bitstream 17 and output (Step S408). An exemplary syntax structure that the encoded bitstream 17 may have will be described with reference to FIG. 10. The following explanation is based on the assumption that the filter data 15 is defined in units of slice. Instead, the filter data 15 may defined in units of other type of area, for example, macroblock or frame.

As shown in FIG. 10, the syntax has three layers, high level syntax 500, slice level syntax 510 and macroblock level syntax 520.

The high level syntax 500 includes sequence parameter set syntax 501 and picture parameter set syntax 502. The high level syntax 500 defines data necessary in any layer higher (e.g., sequence or picture) than slices.

The slice level syntax 510 includes a slice header syntax 511, slice data syntax 512 and loop filter data syntax 513, and defines data necessary in each slice.

The macroblock level syntax 520 includes macroblock layer syntax 521 and macroblock prediction syntax 522, and defines data necessary in each macroblock (e.g., quantized transform coefficient data, prediction mode information, and motion vectors).

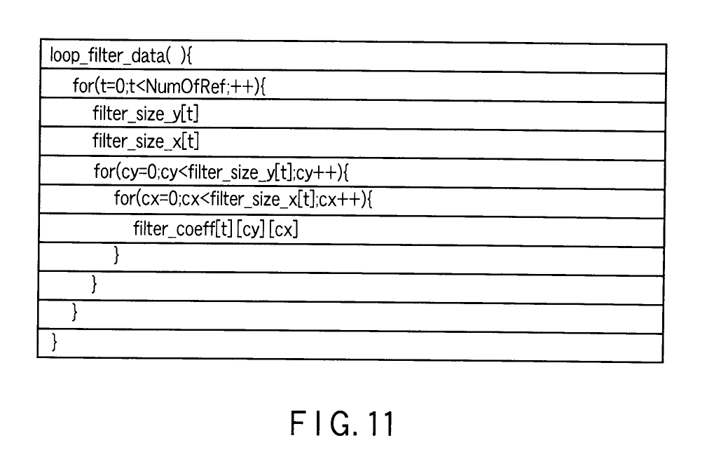

In the loop filter data syntax 513, the filter data 15 is described as shown in FIG. 11. In FIG. 11, filter_coeff [t] [cy] [cx] is a filter coefficient. The pixel to which this filter coefficient is applied is defined by time t and coordinate (cx,cy). Further, filter_size_y[t] and filter_size_x[t] represent the filter size as measured in space directions of the image at time t, and NumOfRef represents the number of reference images. The filter size need not be described in the syntax, as filter data 15, if it has a fixed size in both the encoding side and the decoding side.

### (Moving Image Decoding Apparatus)

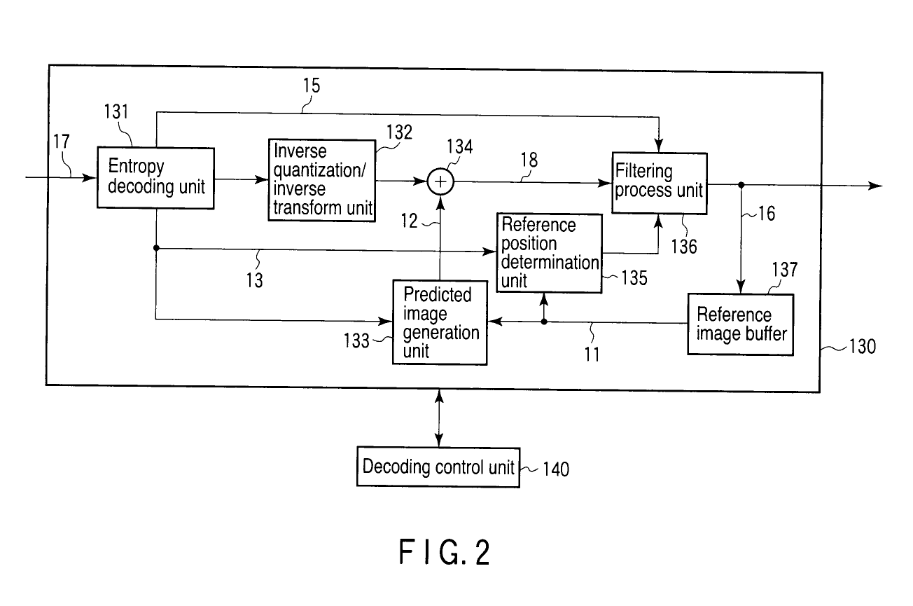

As shown in FIG. 2, a moving image decoding apparatus according to this embodiment has a decoding unit 130 and a decoding control unit 140. The decoding unit 130 includes an entropy decoding unit 131, an inverse quantization/inverse transform unit 132, a predicted image generation unit 133, an addition unit 134, a reference position determination unit 135, a filtering process unit 136, and a reference image buffer 137. The decoding control unit 140 controls the decoding unit 130, performing various controls such as decoding timing control.

The entropy decoding unit 131 decodes, in accordance with a predetermined syntax structure as shown in FIG. 10, each code string of syntax contained in the encoded bitstream 17. To be more specific, the entropy decoding unit 131 decodes the quantized transform coefficient, motion information 13, filter data 15, prediction mode information, block-size switching information, quantization parameter, etc. The entropy decoding unit 131 inputs the quantized transform coefficient to the inverse quantization/inverse transform unit 132, the filter data 15 to the filtering process unit 136, and the motion information 13 to the reference position determination unit 135 and predicted image generation unit 133.

The inverse quantization/inverse transform unit 132 receives the quantized transform coefficient from the entropy decoding unit 131 and performs inverse quantization on this coefficient in accordance with the quantization parameter, thereby decoding the transform coefficient. The inverse quantization/inverse transform unit 132 further performs, on the transform coefficient decoded, the inverse transform of the transform performed in the encoding side, thereby decoding the prediction error. The inverse quantization/inverse transform unit 132 performs, for example, IDCT or inverse wavelet transform. The prediction error thus decoded (hereinafter called “decoded prediction error”) is input to the addition unit 134.

The predicted image generation unit 133 generates a predicted image 12 of the similar type as generated in the encoding side. The predicted image generation unit 133 reads the reference image 11 that has been already decoded, from the reference image buffer 137, and uses the motion information 13 supplied from the entropy decoding unit 131, thereby performing motion-compensated prediction. The encoding side may perform a different prediction scheme such as intra prediction. If this is the case, the predicted image generation unit 133 generates a predicted image 12 based on such prediction scheme. The predicted image generation unit 133 inputs the predicted image to the addition unit 134.

The addition unit 134 adds the decoded prediction error output from the inverse quantization/inverse transform unit 132 to the predicted image 12 output from the predicted image generation unit 133, thereby generating a decoded image 18. The addition unit 134 outputs the decoded image 18 to the filtering process unit 136.

The reference position determination unit 135 reads the reference image 11 from the reference image buffer 137, and uses the motion information 13 output from the entropy decoding unit 131, thereby determining a reference position similar to the position determined in the encoding side. More specifically, if the motion information 13 is a motion vector, the reference position determination unit 135 determines, as reference position, a position in the reference image 11 designated by the motion vector. The reference position determination unit 135 notifies the reference position, thus determined, to the filtering process unit 136.

The filtering process unit 136 uses the reference image 11 shifted in position with respect to the reference position determined by the reference position determination unit 135, and performs a time-space filtering process in accordance with the filter data 15 output from the entropy decoding unit 131, thereby generating a reconstructed image 16. The filtering process unit 136 stores the reconstructed image 16 as reference image 11 associated with the decoded image 18, in the reference image buffer 137. The reference image buffer 137 temporarily stores, as reference image 11, the reconstructed image 16 output from the filtering process unit 136. The reconstructed image 16 will be read from the reference image buffer 137, as is needed.

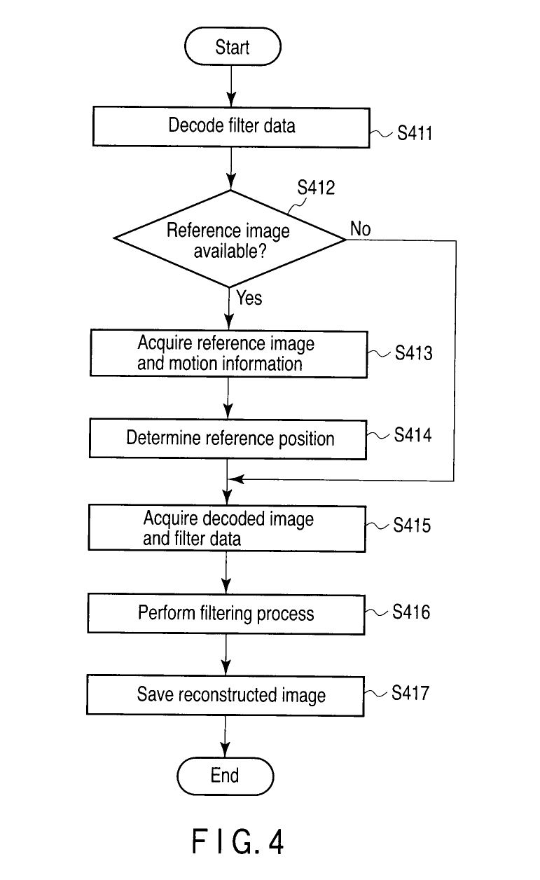

How the reconstructed image 16 is generated in the moving image decoding apparatus according to this embodiment will be explained in the main, with reference to the flowchart of FIG. 4.

First, the entropy decoding unit 131 decodes the filter data 15 from the encoded bitstream 17, in accordance with a predetermined syntax structure (Step S411). Note that the entropy decoding unit 131 decodes the quantized transform coefficient and motion information 13, too, in Step S411. The addition unit 134 adds the decoded prediction error obtained in the inverse quantization/inverse transform unit 132, to the predicted image 12 generated by the predicted image generation unit 133, thereby generating a decoded image 18.

Whether the decoded image 18 has been generated from the predicted image 12 based on the reference image 11 is determined (Step S412). If the decoded image 18 has been generated from the predicted image 12 based on the reference image 11, the reference position determination unit 135 acquires the reference image 11 and the motion information 13 (Step S413), and determines the reference position (Step S414). The process then goes to Step S415. On the other hand, if the decoded image 18 has been generated from the predicted image 12 not based on the reference image 11, the process jumps to Step S415, skipping Steps S413 and S414.

In Step S415, the filtering process unit 136 acquires the decoded image 18 and filter data 15. If the reference position has been determined in Step S414, the filtering process unit 136 acquires the reference position for each reference image 11, too.

Next, the filtering process unit 136 uses the reference image 11 shifted in position with respect to the reference position determined in Step S414, and performs a time-space filtering process on the decoded image 18 in accordance with the filter data 15 acquired in Step S415 (Step S416). To be more specific, the filtering process unit 136 applies the filter coefficient contained in the filter data 15 to a pixel of the decoded image 18 and a pixel of the reference image 11, which assumes the same position as the pixel of the decoded image 18. Thus, the filtering process unit 136 generates the pixels of the reconstructed image 16, one after another. The reconstructed image 16, thus generated in Step S416, is saved in the reference image buffer 137 (Step S417). The reconstructed image 16 is supplied, as output image, to an external apparatus such as a display.

If the decoded image 18 has been generated from the predicted image 12 not based on the reference image 11, the filtering process unit 136 will perform a spatial filtering process in accordance with the filter data 15, thereby generating a reconstructed image 16 (Step S416).

As has been explained, the moving image encoding apparatus according to this embodiment sets filter data to accomplish a time-space filtering process, thereby to make the local decoded image similar to the original image, and uses, as reference image, the reconstructed image generated through the time-space filtering process performed on the basis of the filter data. The moving image encoding apparatus according to this embodiment can therefore improve the quality of the reference image and increase the encoding efficiency. In addition, the moving image decoding apparatus according to this embodiment performs time-space filtering process on a decoded image in accordance with the filter data, thereby generating a reconstructed image and outputting the reconstructed image. The moving image decoding apparatus can therefore improve the quality of the output image.

The moving image encoding apparatus and the moving image decoding apparatus, both according to this embodiment, perform a time-space filtering process. They can therefore improve the quality of output image, better than by the aforementioned post filter (described in the reference document) which merely performs a spatial filtering process. Further, the moving image decoding apparatus according to this embodiment can use a reference image identical to the reference image used in the moving image encoding apparatus, in order to generate a predicted image. This is because the time-space filtering process is performed by using the filter data set in the moving image encoding apparatus.

### Second Embodiment

### Moving Image Encoding Apparatus

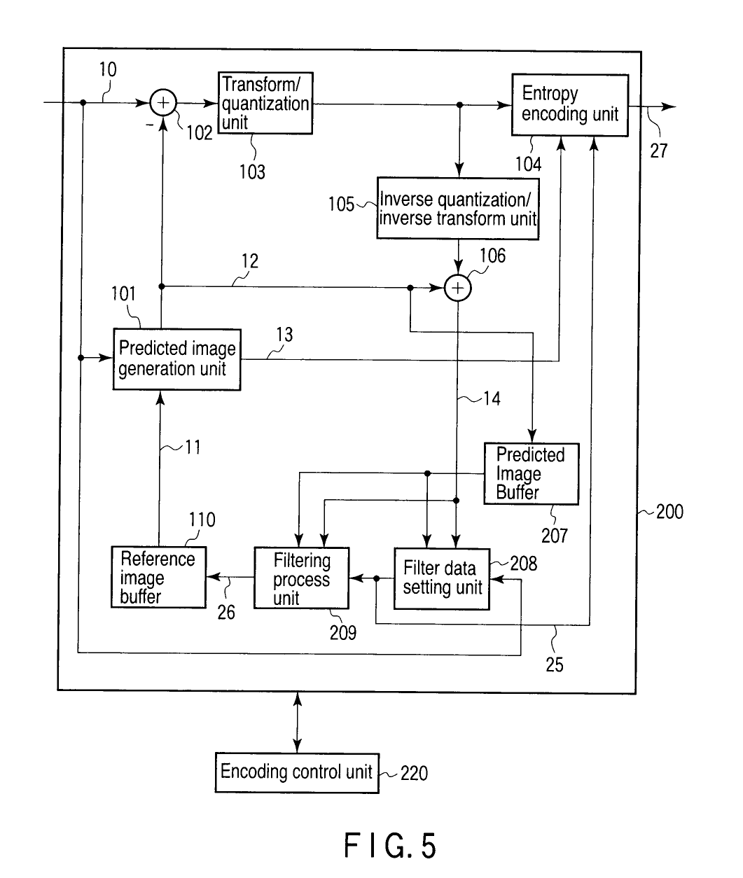

As FIG. 5 shows, a moving image encoding apparatus according to a second embodiment differs from the moving image encoding apparatus according to the first embodiment (see FIG. 1) in that a predicted image buffer 207, a filter data setting unit 208 and a filtering process unit 209 replace the reference position determination unit 107, filter data setting unit 108 and filtering process unit 109, respectively. Hereinafter, the components identical to those shown in FIG. 1 will be designated by the same reference numbers, and the components shown in FIG. 5 and different from those of the first embodiment will be described in the main.

The predicted image buffer 207 receives a predicted image 12 from a predicted image generation unit 101 and temporarily stores the predicted image 12. The predicted image 12 is read from the predicted image buffer 207, as needed, by the filter data setting unit 208 and filtering process unit 209. The predicted image 12 has been compensated in terms of motion. Therefore, a reference position need not be determined, unlike in the moving image encoding apparatus according to the first embodiment, wherein the reference position determination unit 107 determines a reference position.

The filter data setting unit 208 uses a local decoded image 14 and the predicted image 12, setting filter data 25 that contains a time-space filter coefficient that is used to reconstruct an original image. The filter data setting unit 208 inputs the filter data 25 to the entropy encoding unit 104 and filtering process unit 209.

The filtering process unit 209 uses the predicted image 12 and performs a time-space filtering process on the local decoded image 14 in accordance with the filter data 25 output from the filter data setting unit 208, thereby generating a reconstructed image 26. The filtering process unit 209 outputs the reconstructed image 26 to a reference image buffer 110. The reference image buffer 110 stores the reconstructed image 26 as a reference image 11 associated with the local decoded image 14.

### (Moving Image Decoding Apparatus)

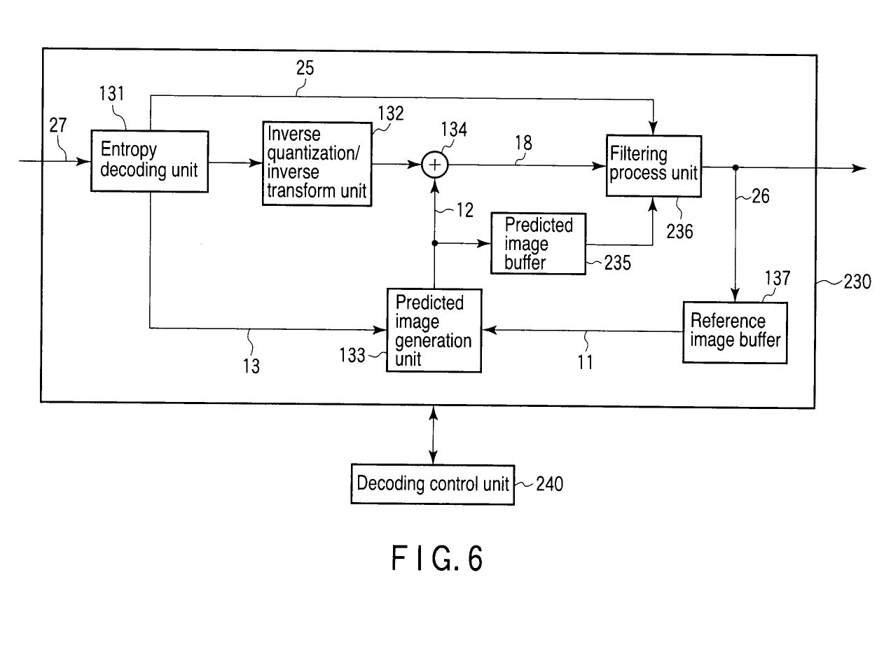

As shown in FIG. 6, a moving image decoding apparatus according to this embodiment differs from the moving image decoding apparatus according to the first embodiment (see FIG. 2) in that a predicted image buffer 235 and a filtering process unit 236 replace the reference position determination unit 135 and filer process unit 136 (both shown in FIG. 2), respectively. Hereinafter, the components identical to those shown in FIG. 2 will be designated by the same reference numbers, and the components shown in FIG. 6 and different from those of the first embodiment will be described in the main.

The predicted image buffer 235 receives a predicted image 12 from a predicted image generation unit 133 and temporarily stores the predicted image 12. The predicted image 12 is read, as needed, from the predicted image buffer 235 to the filtering process unit 236. The predicted image 12 has been compensated in terms of motion. Therefore, a reference position need not be determined, unlike in the moving image decoding apparatus according to the first embodiment, wherein the reference position determination unit 135 determines a reference position.

The filtering process unit 236 uses the predicted image 12 and performs a time-space filtering process in accordance with the filter data 25 output from an entropy decoding unit 131, thereby generating a reconstructed image 26. The filtering process unit 236 stores the reconstructed image 26 as reference image 11 associated with the decoded image 18, in a reference image buffer 137.

As has been explained, the moving image encoding apparatus according to this embodiment sets filter data to accomplish a time-space filtering process, thereby to make the local decoded image similar to the original image, and uses, as reference image, the reconstructed image generated through the time-space filtering process performed on the basis of the filter data. The moving image encoding apparatus according to this embodiment can therefore improve the quality of the reference image and increase the encoding efficiency. In addition, the moving image decoding apparatus according to this embodiment performs time-space filtering process on a decoded image in accordance with the filter data, thereby generating a reconstructed image and outputting the reconstructed image. The moving image decoding apparatus according this embodiment can therefore improve the quality of the output image.

Moreover, the moving image encoding apparatus and moving image decoding apparatus, according to this embodiment, differ from the moving image encoding apparatus and moving image decoding apparatus, according to the first embodiment, in that they utilize a predicted image instead of a reference image and motion information, whereby the reference position need not be determined in order to accomplish a time-space filtering process.

Furthermore, the moving image encoding apparatus and the moving image decoding apparatus, both according to this embodiment, perform a time-space filtering process. They can therefore improve the quality of output image, better than by the aforementioned post filter (described in the reference document) which merely performs a spatial filtering process. Still further, the moving image decoding apparatus according to this embodiment can use a reference image identical to the reference image used in the moving image encoding apparatus, in order to generate a predicted image. This is because the time-space filtering process is performed by using the filter data set in the moving image encoding apparatus.

### Third Embodiment

### Moving Image Encoding Apparatus

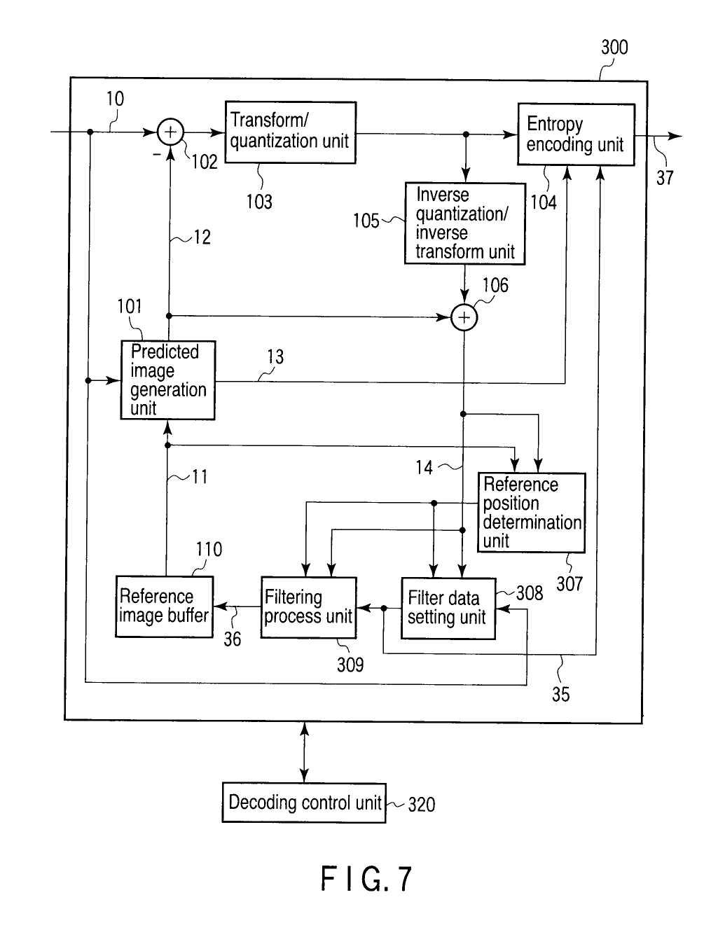

As shown in FIG. 7, a moving image encoding apparatus according to a third embodiment differs from the moving image encoding apparatus according to the first embodiment (see FIG. 1) in that a reference position determination unit 307, a filter data setting unit 308 and a filtering process unit 309 replace the reference position determination unit 107, filter data setting unit 108 and filtering process unit 109, respectively. Hereinafter, the components identical to those shown in FIG. 1 will be designated by the same reference numbers, and the components shown in FIG. 7 and different from those of the first embodiment will be described in the main.

The reference position determination unit 307 does not use motion information 13 as the reference position determination unit 107 does in the moving image encoding apparatus according to the first embodiment. Rather, the reference position determination unit 307 utilizes the pixel similarity between a reference image 11 and a local decoded image 14, thereby to determine a reference position. For example, the reference position determination unit 307 determines the reference position based on block matching between the reference image 11 and the local decoded image 14.

That is, the reference position determination unit 307 searches the reference image 11 for the position where the sum of absolute difference (SAD) for a given block included in the local decoded image 14 is minimal. The position thus found is determined as reference position. To calculate SAD, the following expression (4) is used:

$$SAD = {\sum }_{x , y}^{B} \vert D ( x , y ) - R ( x + mx , y + my ) \vert \qquad ( 4 )$$

In Expression (4), B is the block size, D(x,y) is the pixel value at a coordinate (x,y) in the local decoded image 14, R(x,y) is the pixel value at a coordinate (x,y) in the reference image 11, mx is the distance by which the reference image 11 shifts in the horizontal direction, and my is the distance by which the reference image 11 shifts in the vertical direction. If block size B is 4×4 pixels in Expression (4), sum of difference absolute values for 16 pixels will be calculated. The horizontal shift amount mx and the vertical shift amount my, at which SAD calculated by Expression (4) is minimal, are determined as the above-mentioned reference position.

Generally, the predicted image generation unit 101 performs a similar process in order to estimate a motion. The motion information 13 actually selected is determined from the encoding cost based on not only SAD, but also the code rate. That is, there may be a reference position where the pixel similarity between the reference image 11 and local decoded image 14 is higher than at the position indicated by the motion information 13. The reference position determination unit 307 therefore helps to increase the reproducibility of a reconstructed image 36 (later described) more than that of the reconstructed image 16 or 26. Note that, as the index of the pixel similarity, sum of squared difference (SSD) or the result of frequency transform (e.g., DCT or Hadamard transform) of pixel value difference may be used in place of sum of absolute difference (SAD).

The filter data setting unit 308 uses the local decoded image 14 and the reference image 11 shifted in position in accordance with the reference position determined by the reference position determination unit 307, thereby setting filter data 35 containing a time-space filter coefficient to be used to reconstruct an original image. The filter data setting unit 308 inputs the filter data 35 to the entropy encoding unit 104 and filtering process unit 309.

The filtering process unit 309 uses the reference image 11 shifted in position with respect to the reference position determined by the reference position determination unit 307, and performs a time-space filtering process on the local decoded image 14 in accordance with the filter data 35 output from the filter data setting unit 308, thereby generating the reconstructed image 36. The filtering process unit 309 outputs the reconstructed image 36 to a reference image buffer 110. The reference image buffer 110 stores the reconstructed image 36 as a reference image 11 associated with the local decoded image 14.

### (Moving Image Decoding Apparatus)

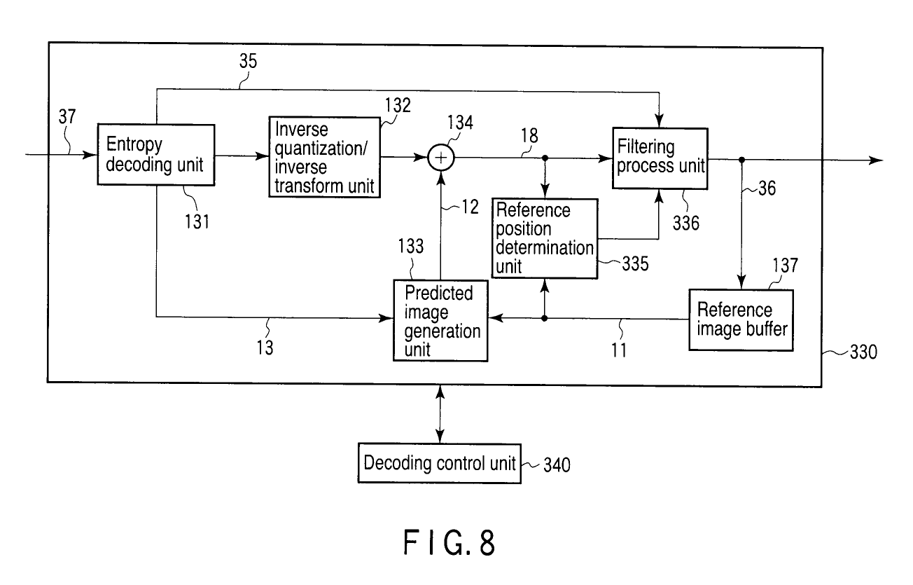

As shown in FIG. 8, a moving image decoding apparatus according to this embodiment differs from the moving image decoding apparatus according to the first embodiment (see FIG. 2) in that a reference position determination unit 335 and a filtering process unit 336 replace the reference position determination unit 135 and filtering process unit 136, respectively. Hereinafter, the components identical to those shown in FIG. 2 will be designated by the same reference numbers, and the components shown in FIG. 8 and different from those of the first embodiment will be described in the main.

The reference position determination unit 335 does not use motion information 13 as the reference position determination unit 135 does in the moving image decoding apparatus according to the first embodiment. Rather, the reference position determination unit 335 utilizes the pixel similarity between a reference image 11 and a decoded image 18, thereby to determine a reference position. The reference position determination unit 335 notifies the reference position, thus determined, to the filtering process unit 336.

The filtering process unit 336 uses the reference image 11 shifted in position with respect to the reference position determined by the reference position determination unit 335, in accordance with the filter data 35 output from an entropy decoding unit 131, thereby performing a time-space filtering process on the decoded image 18 and generating a reconstructed image 36. The filtering process unit 336 stores the reconstructed image 36 as reference image 11 associated with the decoded image 18, in a reference image buffer 137.

As has been explained, the moving image encoding apparatus according to this embodiment sets filter data to accomplish a time-space filtering process, thereby to make the local decoded image similar to the original image, and uses, as reference image, the reconstructed image generated through the time-space filtering process performed on the basis of the filter data. The moving image encoding apparatus according to this embodiment can therefore improve the quality of the reference image and increase the encoding efficiency. In addition, the moving image decoding apparatus according to this embodiment performs time-space filtering process on a decoded image in accordance with the filter data, thereby generating a reconstructed image and outputting the reconstructed image. The moving image decoding apparatus according to this embodiment can therefore improve the quality of the output image.

Moreover, the moving image encoding apparatus and moving image decoding apparatus, according to this embodiment, do not utilize motion information. Instead, they determine a reference position from the pixel similarity between the reference image and the (local) decoded image. Thus, they differ from the moving image encoding apparatus and moving image decoding apparatus, according to the first embodiment, in that the reference position is used, further reducing the error between the reconstructed image and the original image.

Furthermore, the moving image encoding apparatus and the moving image decoding apparatus, both according to this embodiment, perform a time-space filtering process. They can therefore improve the quality of output image, better than by the aforementioned post filter (described in the reference document) which merely performs a spatial filtering process. Still further, the moving image decoding apparatus according to this embodiment can use a reference image identical to the reference image used in the moving image encoding apparatus, in order to generate a predicted image. This is because the time-space filtering process is performed by using the filter data set in the moving image encoding apparatus.

In the moving image encoding apparatuses and moving image decoding apparatuses, according to the first to third embodiments, the time-space filtering process is performed on a local decoded image or a decoded image. Nonetheless, the time-space filtering process may be performed on a local decoded image or a decoded image that has been subjected to the conventional de-blocking filtering process. The moving image encoding apparatuses and moving image decoding apparatuses, according to the first to third embodiments, may additionally perform a spatial filtering process. For example, the apparatuses may selectively perform the time-space filtering process or the spatial filtering process on each frame or a local region (e.g., slice) in each frame.

The moving image encoding apparatuses and moving image decoding apparatuses, according to the first to third embodiments, can be implemented by using a general-use computer as basic hardware. In other words, the predicted image generation unit 101, subtraction unit 102, transform/quantization unit 103, entropy encoding unit 104, inverse quantization/inverse transform unit 105, addition unit 106, reference position determination unit 107, filter data setting unit 108, filtering process unit 109, encoding control unit 120, entropy decoding unit 131, inverse quantization/inverse transform unit 132, predicted image generation unit 133, addition unit 134, reference position determining unit 135, filtering process unit 136, decoding control unit 140, filter data setting unit 208, filtering process unit 209, encoding control unit 220, filtering process unit 236, decoding control unit 240, reference position determination unit 307, filter data setting unit 308, filtering process unit 309, encoding control unit 320, reference position determination unit 335, filtering process unit 336 and decoding control unit 340 may be implemented as the processor incorporated in the computer executes programs. Hence, moving image encoding apparatuses and moving image decoding apparatuses, according to the first to third embodiments, can be implemented by preinstalling the programs in the computer, by installing the programs by way of a storage media such as a CD-ROM storing the programs, into the computer, or by installing the programs distributed through networks, into the computer. Moreover, the reference image buffer 110, reference image buffer 137, predicted image buffer 207 and predicted image buffer 235 can be implemented, appropriately, by an external or internal memory, an external or internal hard disk drive or an inserted storage medium such as a CD-R, a CD-RW, a DVD-RAM or a DVD-R.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A moving image encoding method comprising:
generating a predicted image of an original image based on a reference image;
performing transform and quantization on a prediction error between the original image and the predicted image to obtain a quantized transform coefficient;
performing inverse quantization and inverse transform on the quantized transform coefficient to obtain a decoded prediction error;
adding the predicted image and the decoded prediction error to generate a local decoded image;
setting filter data containing time-space filter coefficients for reconstructing the original image based on the local decoded image and the reference image;
performing a time-space filtering process on the local decoded image in accordance with the filter data to generate a reconstructed image;
storing the reconstructed image as the reference image; and
encoding the filter data and the quantized transform coefficient.

2. The method according to claim 1, further comprising determining a second pixel in the reference image, which is associated with a first pixel in the local decoded image,
wherein the time-space filtering process is a process of allocating the time-space filter coefficients to the first pixel and second pixel to generate a third pixel in the reconstructed image.

3. The method according to claim 1, wherein the time-space filtering process is a process of allocating the time-space filter coefficients to a first pixel in the local decoded image and a second pixel in an image formed by motion-compensating the reference image with motion information, which occupies an identical position as the first pixel, to generate a third pixel in the reconstructed image.

4. The method according to claim 1, wherein the time-space filtering process is a process of allocating the time-space filter coefficients to a first pixel in the local decoded image and a second pixel in the predicted image, which occupies an identical position as the first pixel, to generate a third pixel in the reconstructed image.

5. The method according to claim 2, wherein the second pixel is determined by performing block matching between the local decoded image and the reference image.

6. The method according to claim 5, wherein the filter data further contains spatial filter coefficients for reconstructing the original image from the local decoded image, and either the time-space filtering process or a spatial filtering process using the spatial filter coefficients is performed on the local decoded image for each frame or each local region in the frame to generate the reconstructed image.

7. The method according to claim 6, wherein the time-space filtering process is performed if the predicted image has been generated by interframe prediction based on the reference image, and the spatial filtering process is performed if the predicted image has been generated by intraframe prediction not based on the reference image, to generate the reconstructed image.

8. A moving image decoding method comprising:
decoding an encoded bitstream in which filter data and a quantized transform coefficient are encoded, the filter data containing time-spatial filter coefficients for reconstructing an original image based on a decoded image and a reference image, and the quantized transform coefficient having been obtained by performing predetermined transform/quantization on a prediction error;
performing inverse quantization/inverse transform on the quantized transform coefficient to obtain a decoded prediction error;
generating a predicted image of the original image based on the reference image;
adding the predicted image and the decoded prediction error to generate the decoded image;
performing time-space filtering process on the decoded image in accordance with the filter data to generate a reconstructed image; and
storing the reconstructed image as the reference image.

9. The method according to claim 8, further comprising determining a second pixel in the reference image, which is associated with a first pixel in the decoded image,
wherein the time-space filtering process is a process of allocating the time-space filter coefficients to the first pixel and second pixel to generate a third pixel in the reconstructed image.

10. The method according to claim 8, wherein the time-space filtering process is a process of allocating the time-space filter coefficients to a first pixel in the decoded image and a second pixel in an image formed by motion-compensating the reference image with motion information, which occupies an identical position as the first pixel, to generate a third pixel in the reconstructed image.

11. The method according to claim 8, wherein the time-space filtering process is a process of allocating the time-space filter coefficients to a first pixel in the decoded image and a second pixel in the predicted image, which occupies an identical position as the first pixel, to generate a third pixel in the reconstructed image.

12. The method according to claim 9, wherein the second pixel is determined by performing block matching between the decoded image and the reference image.

13. The method according to claim 12, wherein the filter data further contains spatial filter coefficients for reconstructing the original image from the decoded image, and either the time-space filtering process or a spatial filtering process using the spatial filter coefficients is performed on the decoded image for each frame or each local region in the frame to generate the reconstructed image.

14. The method according to claim 13, wherein the time-space filtering process is performed if the predicted image has been generated by interframe prediction based on the reference image, and the spatial filtering process is performed if the predicted image has been generated by intraframe prediction not based on the reference image, to generate the reconstructed image.
